(19) United States
(12) Patent Application Publication
(10) Pub. No.: US 2006/0112512 A1
(43) Pub. Date: Jun. 1, 2006

(54) Low friction wiper blade

(75) Inventor: Hugh McNeil, Shoreline, WA (US)

Correspondence Address: SEED INTELLECTUAL PROPERTY LAW GROUP PLLC, 701 FIFTH AVE, SUITE 6300, SEATTLE, WA, 98104-7092, US

(73) Assignee: Bardahl Manufacturing Corporation, Seattle, WA (US)

(21) Appl. No.: 11/267,018

(22) Filed: Nov. 4, 2005

Related U.S. Application Data
(60) Provisional application No. 60/625,363, filed on Nov. 4, 2004.

(51) Int. Cl. B60S 1/38

(52) U.S. Cl. 15/250.48; 977/735; 977/742; 264/122; 264/105

(57) ABSTRACT

A windshield wiper blade composition having low friction coefficient and capable of inhibiting UV light-induced degradation of the wiper blade, comprising a substantially homogeneous mixture of carbon-based nanoparticles dispersed in an elastomer base material.

### CROSS-REFERENCE TO RELATED APPLICATION

This application claims the benefit under 35 U.S.C. § 119(e) of U.S. Provisional Patent Application No. 60/625,363 filed Nov. 4, 2004, which application is incorporated herein by reference in its entirety.

### BACKGROUND OF THE INVENTION

1. Field of the Invention

The present invention relates to a wiper blade having low friction coefficient and to a novel elastomer composition.

2. Description of the Related Art

Wiper blades are most frequently used in vehicles to remove condensations such as rain or snow off windshields. Keeping the wiper blades in good working order is therefore critical in providing a driver with a clear view of the road.

Worn wiper blades not only blur a driver's vision; they can also be a source of nuisance when they produce squeaking and chattering noises. Both environmental and mechanical factors can contribute to the wear and tear of the wiper blades. Currently, commercial wiper blades are generally made from natural rubber reinforced with additives such as carbon blacks. Factors that tend to weaken the integrity of the rubber structure and/or the additive play a critical role in the deterioration of the wiper blades. Sunlight, ozone, airborne contaminants and oil all cause changes in the network of the chemical bonds of the rubber's structure. Extreme temperatures change the physical characteristics of the rubber. For example, at freezing temperature, the wiper blades become brittle and cracks are likely to form; whereas in hot weather, the wiper blades tend to “melt” and become misshapen and unable to conform to the glass surface. Abrasive substances such as dirt, dust and road grime on the windshield wear away the cutting edge of the wiper blades that come into contact with the glass. Typically, drivers are advised to replace their windshield wiper blades every six months and need to do so even more frequently if they live in places where weather conditions are extreme.

While physical deterioration of the wiper blade rubber no doubt causes unsatisfactory wiping performance, relatively new wiper blades may not provide the desired level of performance if the wiper blades have high friction coefficient. When wiper blades come into direct contact with a glass surface, the friction coefficient is considerably higher than when there is a thin film of water in between them. The problem is likely to manifest itself when the water distribution on the glass surface is uneven, as in the case when there is only light rain. Likewise, when glass surface treatment is used, water tends to bead up and be unable to form a film, the wiper blades will chatter, and streaks are likely to be generated on the glass surface.

Various efforts have been made to reduce the friction coefficient of wiper blades. Among these, subjecting the rubber base material of the wiper blades to a surface treatment with chlorine reduces the friction at little additional cost. The wiping performance, although somewhat improved, remains unsatisfactory, especially when the windshield has been subjected to water-repellent treatment (U.S. Pat. No. 6,696,391). Moreover, the benefit of a reduced friction coefficient can be largely offset by the shortened life of the rubber due to chlorine-induced degradation, which can be particularly aggressive at high temperature.

Less common than the chlorine treatment, Teflon coating of the wiper blade rubber can also reduce the friction coefficient. Wiper blades coated with Teflon, however, are costlier than regular rubber blades. Furthermore, although Teflon contributes to the structural reinforcement of the blade, it does not prevent the rubber from degradation under the environmental elements such as sunlight and ozone.

Silicone rubber has recently emerged as an alternative base for wiper blades. While silicone rubber is superior to the natural rubber in many respects, including its ability to withstand extreme temperatures and its resistance to adverse environmental impacts such as UV light, ozone and pollutants, one debilitating drawback of silicone rubber as the base for wiper blades is that it has very high friction coefficient with respect to glass. Therefore, silicone rubber based wiper blades must be treated with large quantity of fillers or additives that impart lubricant characteristics. (U.S. Pat. Nos. 3,972,850, 5,283,927.) However, the improvement in the wiping performance is accompanied by a significant increase in cost, which is in part due to the higher material cost of the silicone rubber and in part due to the cost of the necessary amount of the friction-reducing additives. Furthermore, silicone rubber processing requires different and generally more costly press and extrusion machinery compared to those used in processing wiper blades made from conventional rubbers.

Therefore, there remains a need in the art for wiper blades that have low friction coefficient, can withstand adverse environmental elements, and do not require additional or expensive fabrication process.

### BRIEF SUMMARY OF THE INVENTION

According to the present invention, one embodiment provides a substantially homogeneous composition of an elastomer base material and nanoparticles. Typically, the elastomer comprises 90-99.8 wt % of the total weight of the composition. More typically, the elastomer comprises 98-99.8 wt % of the total weight of the composition.

Another embodiment of the present invention provides a composition comprising a substantially homogeneous mixture of: 98-99.8 wt % of an elastomer base material; 0.1-1 wt % of carbon nanotubes; and 0.1-1 wt % of fullerenes.

Another embodiment of the present invention provides a wiper blade composition having an elastomer composition comprising a substantially homogeneous mixture of: 98-99.8 wt % of an elastomer base material; 0.1-1 wt % of carbon nanotubes; and 0.1-1 wt % of fullerenes.

A further embodiment of the present invention provides a wiper blade composition having a friction coefficient of less than 2.8 grams per gram weight. More typically, the wiper blade composition has a friction coefficient of 2.0-2.6 grams per gram weight.

Yet another embodiment of the present invention provides a method of making a wiper blade composition comprising an elastomer composition.

### DETAILED DESCRIPTION OF THE INVENTION

In one embodiment, the present invention provides a wiper blade having low friction coefficient with respect to glass surfaces. The wiper blade comprises an elastomer base material having carbon-based nanoparticles dispersed therein. The carbon-based nanoparticles impart lubrication as well as protect the elastomer base material against degradation as a result of harsh environmental elements such as ultra-violet light.

Wiper blades as used herein include any type of squeegees that are intended to be drawn across a smooth surface for purpose of removing liquid from the surface. A typical example is a windshield wiper blade used in automobiles, trains or aircrafts. Other examples include squeegees for cleaning glass surfaces.

Carbon-based nanoparticles, such as carbon nanotubes or fullerenes, have fascinating and significantly different properties from other forms of pure carbon such as diamond and graphite. This is due to their unique physical structures. Carbon nanotubes (CNTs) are hollow cylinders of carbon atoms. Their appearance is that of rolled-up tubes of graphite such that their walls are hexagonal carbon rings. The ends of CNTs are domed structures of 6-membered rings capped by a 5-membered ring. There are generally two types of CNTs: single walled carbon nanotubes (SWNTs) consisting of a single graphene layer, and multi-walled carbon nanotubes (MWNTs) consisting of multiple graphene layers telescoped about one another. CNTs tend to aggregate and form bundles due to significant van der Waals force.

Fullerenes are spheres or elongated spheres of carbon atoms formed by interlocking 6-member rings and 5-member rings. The number of carbon atoms in a fullerene structure may vary, with C₆₀ and C₇₀ being among the most common and stable types of fullerenes.

It has been shown that carbon based nanoparticles such as carbon nanotubes and fullerenes possess superior lubricating properties over other solid lubricants such as graphite and MOS₂. These nanoparticles' chemical inertness and hollow cage structure are believed to lead to high elasticity and allow the particles to roll rather than slide.

The present invention therefore provides a novel elastomer composition wherein carbon-based nanoparticles such as carbon nanotubes and fullerenes are dispersed in an elastomer base material. The composition is suitable for forming wiper blades, as defined herein. The carbon-based nanoparticles, even at small amount, impart superb lubrication for an enduring wiping performance in the wiper blades. Moreover, the carbon-based nanoparticles provide the added benefits of improving the mechanical strength and inhibiting UV-induced degradation of the elastomer base material.

Nanotubes and fullerenes suitable for the present invention need not be of the high grade that is typically required when electrical or optical properties of these nanoparticles are being exploited. For example, it is not required that the carbon nanotubes be SWNTs, which are much costlier than MWNTs. Moreover, the particle size of the carbon nanotubes employed in the wiper blade composition is not limited to any particular size. Mixture of particle sizes may also be employed. Based on the same practical rationale, mixtures of fullerenes of C₆₀-C₇₀ as well as pure fullerenes are acceptable as the additives for the elastomer base.

Nanoparticles such as carbon nanotubes and fullerenes had previously been available only in small-scale production at research laboratories. They can now be inexpensively manufactured on an industrial scale due to recent technological advances such as combustion synthesis. Carbon nanotubes and fullerenes suitable for the present invention can be obtained in bulk from a variety of the suppliers, such as Fullerene Int. Corp. (Tucson, Ariz.), IIjin Nanotech (Korea), MicrotechNano (Indianapolis, Ind.), and Applied Science Inc. (Cedarville, Ohio).

The elastomer base material suitable for the present invention comprises one or more elastomers conventionally used as a wiper blade body in a manufacturing process. Typically, an elastomer can be a crosslinked or crosslinkable polymer. Natural rubber, synthetic rubber, silicone, silicone/Teflon rubber blends and copolymers or a mixture thereof are all suitable elastomers. Other known rubbers such as chloroprene rubber, diene-type rubber, or ethylene propylene rubber are also suitable elastomer for the formation of wiper blades.

The elastomer base material can further comprise other optional additives. For example, the elastomer base material can further include carbon black additive. Typically, carbon black can be present in the elastomer base material at about 15-50% by weight of the total elastomer base material. Carbon black is a reinforcing element as well as a sacrificial protectant to the elastomer. Carbon black absorbs UV light and dissipates the energy as heat. During the process, carbon black itself degrades and turns white/gray. Carbon nanotubes and fullerenes enhance the UV inhibition process because they have comparable absorption coefficient in the UV range as that of carbon black.

In addition to carbon black, other additives or fillers conventionally used in the wiper blade manufacturing can be optionally employed to fine-tune the desired properties of the finishing product. These optional materials include non-reinforcing fillers such as CaCO₃, clay, etc.; cure activators such as stearic acid and zinc oxide; and other additives such as desiccants like CaO. Still other materials such as antioxidants may be included in the composition. Antioxidants include, e.g., polymerized quinolines, hindered amines, phenols and the like known in the art. Selection and amount of optimal materials which would be employed in the composition would be dependent on the use and desired properties of the composition. As such, their selection would be within the skill of those in the art in view of the present disclosure.

Carbon nanotube and fullerenes can be blended in an elastomer base material to provide an elastomer composition. The elastomer composition can then be extruded, molded or vacuumed formed into any requisite shape. In one embodiment, wiper blades are produced by coextrusion of the various cross-linkable polymer mixtures, cross-linking of the coextrudate under heat, and cutting apart the extruded strand to the desired blade lengths. These techniques are also well known to one skilled in the art. The cross-linkable polymer mixtures may contain the usual cross-linking agents and additives, such as sulfur, sulphenamides, peroxides (such as dicumyl peroxide), and soot, zinc oxide and other fillers, and heat, oxidation and ozonolysis stabilizers.

Typical wiper blades generally have a length of approximately 10 to 20 inches and a contact width of about 0.1 inch, yielding a squeegee blade/glass surface contact area of approximately one to two square inches. The friction coefficient of a composition suitable for forming wiper blades has been arrived at with this amount of contact surface area in mind. It has been found that wiper blades that exhibit a friction coefficient greater than about 2.8 grams per gram weight perform poorly due to motor loading, squeaking or chatter.

The wiper blades according to the present invention, on the other hand, have a friction coefficient lower than 2.8 grams per gram weight. More typically, the wiper blades according to the present invention have a coefficient of friction of about 2.0-2.6 grams per gram weight.

Due to the large surface to volume ratio, only a small amount of carbon nanotubes and fullerenes are needed to impart the superb friction-reducing property desired. For example, the combined weight of the nanoparticles can be present in the elastomer base material at about 0.2-10% of the total weight of the elastomer composition. More typically, the combined weight of the nanoparticles can be present in the elastomer base material at about 0.2-2% of the total weight of the elastomer composition. Typically, the carbon nanotubes can be present at 0.1-1 wt %, and co-additive fullerenes can be present at 0.1-1 wt %.

All of the above U.S. patents, U.S. patent application publications, U.S. patent applications, foreign patents, foreign patent applications and non-patent publications referred to in this specification and/or listed in the Application Data Sheet are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A wiper blade comprising an elastomer composition having carbon-based nanoparticles dispersed in an elastomer base material.

2. The wiper blade of claim 1 wherein the carbon-based nanoparticles are present in an amount of 0.2-10 wt % of the total weight of the elastomer composition.

3. The wiper blade of claim 1 wherein the carbon-based nanoparticles are present in an amount of 0.2-2 wt % of the total weight of the elastomer composition.

4. The wiper blade of claim 1 wherein the carbon-based nanoparticles are carbon nanotubes, fullerenes or a mixture thereof.

5. The wiper blade of claim 4 wherein the carbon nanotubes are multi-walled carbon nanotubes and the fullerenes are a mixture of C₆₀ and C₇₀ fullerenes.

6. The wiper blade of claim 4 wherein the carbon nanotubes are present in an amount of about 0.1-1 wt % of the total weight of the elastomer composition and the fullerenes are present in an amount of about 0.1-1 wt % of the total weight of the elastomer composition.

7. The wiper blade of claim 1 wherein the elastomer base material comprises natural rubber, polybutadiene, polyisobutadiene, polychloroprene, poly (ethylene-co-propylene), silicon rubber or a blend thereof.

8. The wiper blade of claim 7 wherein the elastomer base material further comprises carbon black.

9. The wiper blade of claim 8 wherein the carbon black is 15-50% of the total weight of the elastomer base material.

10. The wiper blade of claim 1 having a friction coefficient of less than 2.8 gram per gram weight.

11. The wiper blade of claim 10 having a friction coefficient in the range of 2.0-2.6 gram per gram weight.

12. A method of making a wiper blade comprising:
preparing an elastomer composition by mixing carbon-based nanoparticles in an elastomer base material; and
forming the elastomer composition into the wiper blade.

13. The method of claim 12 wherein the step of forming comprises heating, molding and curing of the elastomer composition.

14. The wiper blade of claim 12 wherein the carbon-based nanoparticles are present in an amount of 0.2-10 wt % of the total weight of the elastomer composition.

15. The method of claim 12 wherein the carbon-based nanoparticles are present in an amount of 0.2-2 wt % of the total weight of the elastomer composition.

16. The method of claim 12 wherein the carbon-based nanoparticles are carbon nanotubes, fullerenes or a mixture thereof.

17. The method of claim 16 wherein the carbon nanotubes are multi-walled carbon nanotubes and the fullerenes are a mixture of C₆₀ and C₇₀ fullerenes.

18. The method of claim 17 wherein the carbon nanotubes are present in an amount of 0.1-1 wt % of the total weight of the elastomer composition and the fullerenes are present in an amount of 0.1-1 wt % of the total weight of the elastomer composition.

19. The method of claim 12 wherein the elastomer base material comprises natural rubber, polybutadiene, polyisobutadiene, polychloroprene, poly (ethylene-co-propylene), silicon rubber or a blend thereof.

20. The method of claim 12 wherein the elastomer base material further comprises carbon black.

21. The method of claim 20 wherein the carbon black is 15-50% of the total weight of the elastomer base material.

22. An elastomer composition comprising carbon-based nanoparticles and an elastomer base material.

23. The elastomer composition of claim 22 wherein the carbon-based nanoparticles are present in an amount of 0.2-10 wt % of the total weight of the elastomer composition.

24. The elastomer composition of claim 22 wherein the carbon-based nanoparticles are present in an amount of 0.2-2 wt % of the total weight of the elastomer composition.

25. The elastomer composition of claim 22 wherein the carbon-based nanoparticles are carbon nanotubes, fullerenes or a mixture thereof.

26. The elastomer composition of claim 25 wherein the carbon nanotubes are multi-walled carbon nanotubes and the fullerenes are a mixture of C₆₀ and C₇₀ fullerenes.

27. The elastomer composition of claim 25 wherein the carbon nanotubes are present in an amount of 0.1-1 wt % of the total weight of the elastomer composition and the fullerenes are present in an amount of 0.1-1 wt % of the total weight of the elastomer composition.

28. The elastomer composition of claim 22 wherein the elastomer base material comprises natural rubber, polybutadiene, polyisobutadiene, polychloroprene, poly (ethylene-co-propylene), silicon rubber or a blend thereof.
